(19) United States
(12) Patent Application Publication
(10) Pub. No.: US 2017/0134394 A1
(43) Pub. Date: May 11, 2017

(54) DATA TRANSMITTING AND RECEIVING METHOD, TRANSMITTER, RECEIVER AND CAN BUS NETWORK

(71) Applicant: Leauto Intelligent Technology (BEIJING) Co.Ltd, Beijing (CN)

(72) Inventors: Yong XU, Beijing (CN); Dan LI, Beijing (CN); WenRui LI, Beijing (CN); Wei LIN, Beijing (CN); Yu ZOU, Beijing (CN); XiaoFei GOU, Beijing (CN); Peng LIU, Beijing (CN)

(73) Assignee: Leauto Intelligent Technology (BEIJING) Co.Ltd, Beijing (CN)

(21) Appl. No.: 14/977,635

(22) Filed: Dec. 21, 2015

(30) Foreign Application Priority Data
Nov. 11, 2015 (CN) 201510766262.3

(51) Int. Cl. H04L 29/06

(52) U.S. Cl. CPC H04L 63/123; H04L 63/0876; H04L 63/0435

(57) ABSTRACT

The present disclosure provides data transmitting and receiving methods, transmitter, receiver and CAN bus network. The present disclosure may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present disclosure, such accidents may be avoided.

### CROSS-REFERENCE TO RELATED APPLICATIONS

This application claims priority to Chinese Patent Application No. 201510766262.3, with the title of “DATA TRANSMITTING AND RECEIVING METHOD, TRANSMITTER, RECEIVER AND CAN BUS NETWORK”, filed on Nov. 11, 2015, which is hereby incorporated by reference in its entirety.

### FIELD OF TECHNOLOGY

The present disclosure relates to communication technique, and more particularly to data transmitting and receiving methods, transmitter, receiver and CAN bus network.

### BACKGROUND

Controller Area Network (CAN) bus protocol is a serial communication protocol of International Organization for Standardization (ISO). CAN bus may be in the scope of industrial field bus. Comparing with general communication bus, data communication via CAN bus may have significant performance of real-time and flexibility. Due to its good performance and unique design, CAN bus now attracts more and more attention, especially in the application in vehicle field.

A vehicle may consist of four systems: engine, chassis, vehicle body, and electronics. Each system may include a plurality Electronic Control Unit (ECU). It may be necessary for these ECUs to communicate with each other, and the communication may depend on a various kinds of bus protocol, which may include CAN bus.

CAN bus may be the most importance bus inside the vehicle body and may currently be the backbone network inside the vehicle. The CAN bus may connect modules such as engine control system, gear control system, auto-cruise control system, instrumentation and body control module. However, the inventors find that there are more and more attacks on the CAN bus, which may cause leakage of information and thereby there may be danger for safe driving.

### SUMMARY

The present disclosure provides data transmitting and receiving methods, transmitter, receiver and CAN bus network, which may solve the technical problem of leakage of information due to that the CAN bus may be vulnerable to attacks.

To achieve the above object, the embodiment of the present disclosure may provide the following technical solutions.

In the first aspect, the present disclosure provides a data transmitting method, including: acquiring a CAN bus message generated by an ECU; encrypting a data field in the CAN bus message to obtain a message to be transmitted; and transmitting the message to be transmitted on the CAN bus via broadcasting.

In the second aspect, the present disclosure provides a data receiving method, including: performing interception on the CAN bus to acquire an encrypted CAN bus message of an ECU; decrypting a data field in the encrypted CAN bus message to obtain a message to be transmitted; and transmitting the message to be transmitted to the ECU.

In the third aspect, the present disclosure provides a transmitter including: an ECU interface configured to acquire the CAN bus message generated by an ECU; an encrypting module configured to encrypt a data field in the CAN bus message to obtain a message to be transmitted; and a bus interface configured to transmit the message to be transmitted on the CAN bus via broadcasting.

In the fourth aspect, the present disclosure provides a receiver including: an intercepting module configured to perform interception on the CAN bus to acquire an encrypted CAN bus message of an ECU; a decrypting module configured to decrypt a data field in the encrypted CAN bus message to obtain a message to be transmitted; and a transmitting module configured to transmit the message to be transmitted to the ECU.

In the fifth aspect, the present disclosure provides a transmitter, including: one or more processors; a memory; and one or more programs stored in the memory and configured to perform operations when executed by the one or more processors, wherein the operations include: acquiring a CAN bus message generated by an ECU; encrypting a data field in the CAN bus message to obtain a message to be transmitted; and transmitting the message to be transmitted on a CAN bus via broadcasting.

In the sixth aspect, the present disclosure provides a receiver, including: one or more processors; a memory; and one or more programs stored in the memory and configured to perform operations when executed by the one or more processors, wherein the operations include: performing interception on a CAN bus to acquire an encrypted CAN bus message of an ECU; decrypting a data field in the encrypted CAN bus message to obtain a message to be transmitted; and transmitting the message to be transmitted to the ECU.

In the seventh aspect, the present disclosure provides a CAN bus network including: the transmitter as described above, the receiver as described above, an ECU, and a CAN bus, wherein the transmitter may be connected with the ECU and the CAN bus respectively, and the receiver may be connected with the ECU and the CAN bus respectively.

The data transmitting and receiving methods, transmitter, receiver and CAN bus network may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is because that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided.

The above description is merely the general description of the technical solutions of the present disclosure. To better understanding of the technical means of the present disclosure, it may be possible to implement according to the contents of the present disclosure. In the following, embodiments may be described for better understanding of above and other objects, technical features and advantages of the present disclosure.

### BRIEF DESCRIPTION OF THE DRAWINGS

Various kinds of other advantages and benefits may be obvious to one skilled in the art based on the following detailed description of the preferable embodiments. Drawings may be only used to illustrate the preferable embodiments, but not the limitation on the present disclosure. Same reference symbol may refer to same components throughout the drawings. In the drawing:

FIG. 1 illustrates a typical form of CAN message;

FIG. 2 is a flowchart of a data transmitting method provided by the first embodiment of the present disclosure;

FIG. 3 is a flowchart of a data receiving method provided by the second embodiment of the present disclosure;

FIG. 4 is a structural diagram of a transmitter 40 provided by the third embodiment of the present disclosure;

FIG. 5 is a structural diagram of another transmitter 40 provided by the fourth embodiment of the present disclosure;

FIG. 6 is a structural diagram of a receiver 60 provided by the fifth embodiment of the present disclosure;

FIG. 7 is a structural diagram of another receiver 60 provided by the sixth embodiment of the present disclosure;

FIG. 8 is a structural diagram of a CAN bus network provided by the seventh embodiment of the present disclosure;

FIG. 9 is a structural view of a transmitter provided by the present disclosure; and

FIG. 10 is a structural view of a receiver provided by the present disclosure.

### DESCRIPTION OF THE EMBODIMENTS

In the following, detailed description may be made on exemplary embodiments of the present disclosure. Although drawings show the exemplary embodiments of the present disclosure, it should be noted that, the present disclosure may be implemented in various kinds of forms without being limited by the embodiments described here. On the contrary, these embodiments are provided for more complete understanding of the present disclosure and to completely convey the scope of the present disclosure to skilled in the art.

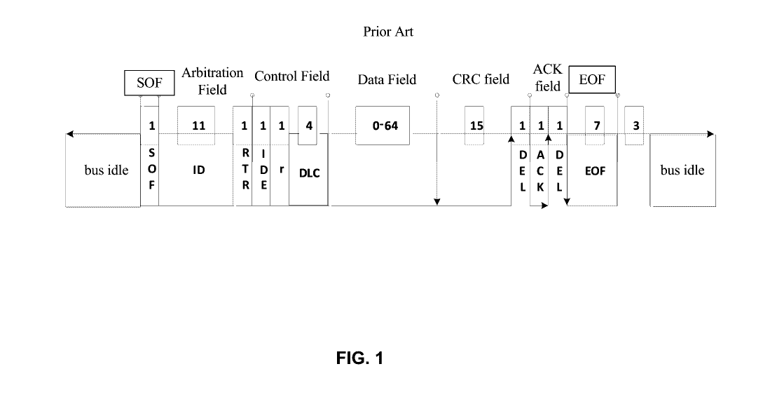

Generally, a CAN message may consist of seven different Bit Fields: SOF (Start of), Arbitration Field, Control Field, Data Field, Cyclic Redundancy Check (CRC) field, ACK field and EOF (End of). FIG. 1 illustrates a typical form of CAN message. As shown in FIG. 1, the length of SOF may be 1 bit. The Arbitration Field may consist of 6 bits, including 2 reserved bits, wherein the first reserved bit may be used as an IDE (Identifier Extention), and 4 DLCs (Data Length Code). The Data Field may have a length of 0-64 bits. The CRC field may consist of 15 CRC fileds and one stealth DEL (Delimiter) with a length of 0-64 bits. The ACK field may consist of an ACK gap and an ACK DEL stealth bits transmitted by the transmitter. Each message may be ended with an EOF filed with a series of seven implicit bits. Therefore, the receiver may detect the end of transmission of a frame message properly.

However, there are more and more attacks on the CAN bus, which may cause leakage of information and thereby there may be danger for safe driving. The reason is because that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided.

In the following, detailed description may be made on the data transmitting and receiving methods, transmitter, receiver and CAN bus network of the embodiments of the present disclosure in connection with drawings.

### First Embodiment

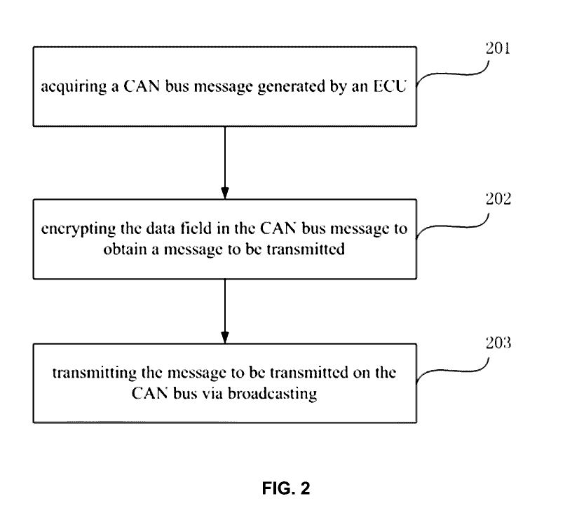

FIG. 2 is a flowchart of a data transmitting method provided by the first embodiment of the present disclosure. The method of the present embodiment may be performed at a node in a CAN bus network. There is at least one ECU at each node in the CAN bus network. As shown in FIG. 2, the method may include:

Step 201, acquiring a CAN bus message generated by an ECU.

More particularly, the structure of a CAN bus message may be as shown in FIG. 1, including a data field. In the related art, the CAN bus messages are always transmitted in plain-text, and thus there are more and more attacks on the CAN bus, which may cause leakage of information and thereby there may be danger for safe driving.

Step 202, encrypting a data field in the CAN bus message to obtain a message to be transmitted.

More particularly, the data field in the CAN bus message may be encrypted with a symmetry encryption algorithm, for example, Advanced Encryption Standard (AES).

Furthermore, the data field in the CAN bus message may include an encryption indication bit and a data bit. The encryption indication bit may be configured to indicate whether or not the message is encrypted, wherein the data bit may be configured to carry data. Therefore, before step 202, the method may further include confirming that the CAN bus message is encrypted according to the indication of the encryption indication bit of the data field in the CAN bus message. As a possible implementation, the encryption indication bit may be the first bit. For example, if the value of the encryption indication bit is 0, it means that the message is not encrypted, and step 202 may be not performed; and if the value of the encryption indication bit is 1, it means the message is encrypted and step 202 may be performed. In step 202, the data bit in the data field in the message may be encrypted.

Step 203, transmitting the message to be transmitted on the CAN bus via broadcasting.

More particularly, when data is transmitted at one node of the CAN bus, the data may be broadcast to all nodes in the network in a form of message. Each node may intercept the data no matter whether or not this message is intended to be transmitted to itself and compare the identification of itself and the value of the Arbitration Field of the message with respect to the message obtained by interception. If they are same, it means that the message obtained by interception is intended to be transmitted to itself. If they are different, it means that the message obtained by interception is not intended to be transmitted to itself.

Furthermore, before step 203, the method may further include performing validation check on the message to be transmitted according to the Arbitration Field and CRC field in the message to be transmitted.

More particularly, CRC series may be obtained by performing calculation according to the SOF, Arbitration Field, Control Field, Data Field of a frame and the value of the CRC field in the message may be compared with the calculated CRC series to obtain a comparison result. Furthermore, the RTR bit in the Arbitration Field should be “dominance” in the data frame, but should be “implicit” in a remote frame, which is a mark for distinguish data frame and remote frame. After the check and the message to be transmitted is confirmed, the message may be transmitted.

The present embodiment may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided.

### Second Embodiment

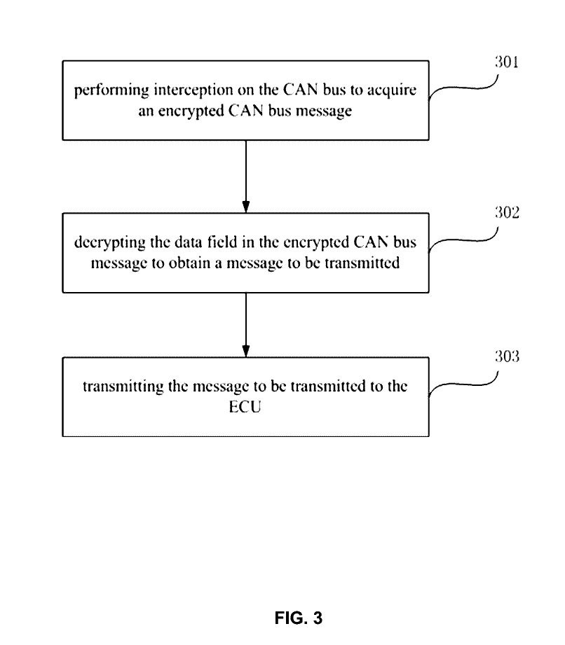

FIG. 3 is a flowchart of a data receiving method provided by the second embodiment of the present disclosure. The method in the present embodiment may be a data receiving method corresponding to the data transmitting method provided by the first embodiment. The data receiving method may be performed at a node in a CAN bus network. There is at least one ECU at each node in the CAN bus network. As shown in FIG. 2, the method may include:

Step 301, performing interception on the CAN bus to acquire an encrypted CAN bus message of ECU.

More particularly, interception may be performed on the CAN bus and an encrypted CAN bus message whose value of Arbitration Field is same as the identification code of the ECU may be acquired. The reason is that when data is transmitted at one node of the CAN bus, the data may be broadcast to all nodes in the network in a form of message. Each node may intercept the data no matter whether or not this message is intended to be transmitted to itself and compare the identification of itself and the value of the Arbitration Field of the message with respect to the message obtained by interception. If they are same, it means that the message obtained by interception is intended to be transmitted to itself. If they are different, it means that the message obtained by interception is not intended to be transmitted to itself.

Step 302, decrypting a data field in the encrypted CAN bus message to obtain a message to be transmitted.

More particularly, the data field in the CAN bus message may be decrypted with a symmetry encryption algorithm same as the algorithm provided in the encrypting step, for example, Advanced Encryption Standard (AES).

It should be noted that, the encryption mentioned in each embodiment of the present disclosure may use asymmetry algorithm in additional to the symmetry algorithm. There is no limitation in each embodiment of the present disclosure.

Furthermore, the data field in the CAN bus message may include an encryption indication bit and a data bit. The encryption indication bit may be configured to indicate whether or not the message is encrypted, wherein the data bit may be configured to carry data. Therefore, before step 302, the method may further include confirming that the CAN bus message is encrypted according to the indication of the encryption indication bit of the data field in the CAN bus message. As a possible implementation, the encryption indication bit may be the first bit. For example, if the value of the encryption indication bit is 0, it means that the message is not encrypted, and step 302 may be not performed; and if the value of the encryption indication bit is 1, it means the message is encrypted and step 302 may be performed. In step 302, the data bit in the data field in the message may be decrypted.

Step 303, transmitting the message to be transmitted to the ECU.

More particularly, ECU may receive the message to be transmitted and then perform corresponding operations according to the data field in the message to be transmitted.

The present embodiment may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided. Furthermore, only the CAN bus message of ECU related to the safety in driving in the CAN bus network may be encrypted, and thus the transmission efficiency of CAN bus messages may be improved while ensuring safety, and the cost for CAN bus may be reduced.

### Third Embodiment

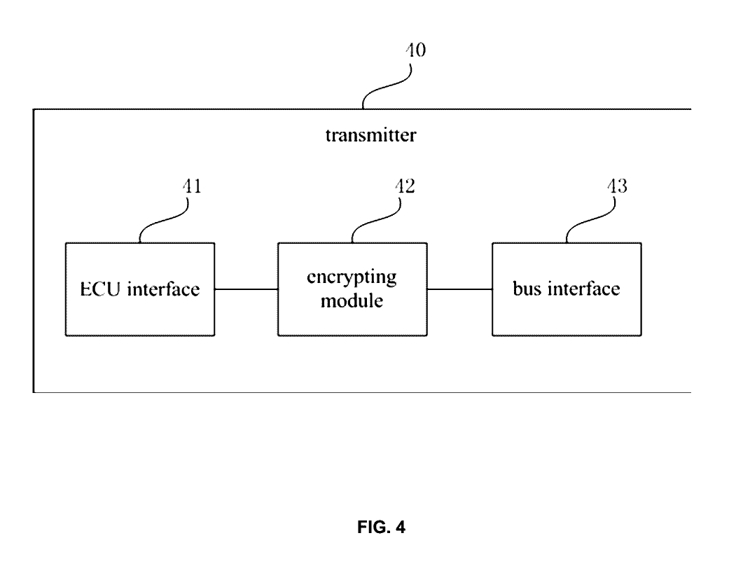

FIG. 4 is a structural diagram of a transmitter 40 provided by the third embodiment of the present disclosure. As shown in FIG. 4, the transmitter 40 may include: an ECU interface 41, an encrypting module 42, and a bus interface 43. The ECU interface 41 may be configured to acquire the CAN bus message generated by an ECU.

The encrypting module 42 may be configured to encrypt a data field in the CAN bus message acquired by the ECU interface 41 to obtain a message to be transmitted.

More particularly, the encrypting module 42 may encrypt the data field in the CAN bus message with a symmetry encryption algorithm, for example, Advanced Encryption Standard (AES).

The bus interface 43 may be configured to transmit the message to be transmitted acquired by the encrypting module 42 on the CAN bus via broadcasting.

More particularly, when data is transmitted at one node of the CAN bus, the bus interface 43 may broadcast the data to all nodes in the network in a form of message. Each node may intercept the data no matter whether or not this message is intended to be transmitted to itself and compare the identification of itself and the value of the Arbitration Field of the message with respect to the message obtained by interception. If they are same, it means that the message obtained by interception is intended to be transmitted to itself. If they are different, it means that the message obtained by interception is not intended to be transmitted to itself.

The present embodiment may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided.

### Fourth Embodiment

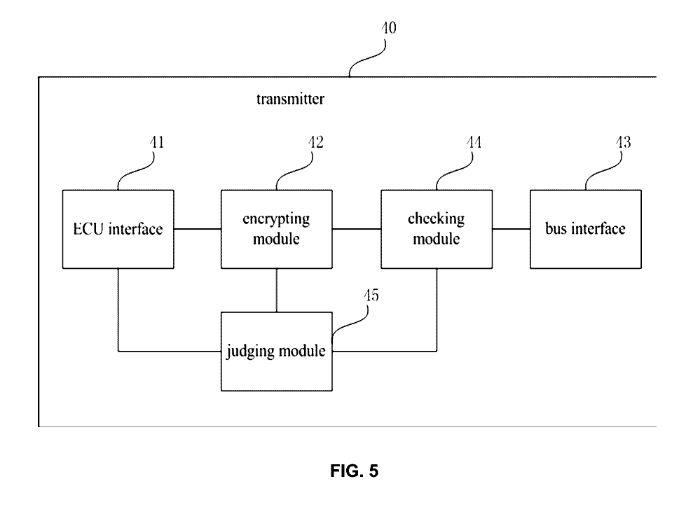

FIG. 5 is a structural diagram of another transmitter 40 provided by the fourth embodiment of the present disclosure. As shown in FIG. 5, on basis of the foregoing embodiment, the transmitter 40 may further include a checking module 44.

The checking module 44 may be configured to perform validation check on the message to be transmitted according to the Arbitration Field and CRC Field in the message to be transmitted acquired by the encrypting module 42.

Furthermore, the data field in the CAN bus message may include an encryption indication bit and a data bit. The encryption indication bit may indicate whether or not the message is encrypted, wherein the data bit may carry data.

As a possible implementation, the encryption indication bit may be the first bit. For example, if the value of the encryption indication bit is 0, it means that the message is not encrypted, and it is unnecessary for the encrypting module 42 to perform encryption; and if the value of the encryption indication bit is 1, it means the message is encrypted and encrypting module 42 may encrypt the message. In encrypting module 42, the data bit in the data field in the message may be encrypted.

The transmitter 40 may further include a judging module 45. The judging module 45 may be configured to confirm whether or not the CAN bus message needs to be encrypted according to the indication of the encryption indication bit of the data field in the CAN bus message acquired by the ECU interface 41.

More particularly, if the CAN bus message confirms that the CAN bus message is encrypted according to the indication of encryption indicating bit in the data field in the CAN bus message, and the CAN bus message may be transmitted to the encrypting module 42; otherwise, the CAN bus message may be transmitted to the bus interface 43 via the checking module 44.

As a possible implementation, if the value of the encryption indication bit is 0, it means that the message is not encrypted, and the judging module 45 may transmit the CAN bus message to the bus interface 43; and if the value of the encryption indication bit is 1, it means the message is encrypted and the judging module 45 may transmit the CAN bus message to the encrypting module 43 and in the encrypting module 42 the data bit in the data field in the message may be encrypted.

Accordingly, the encrypting module 42 may be further configured to encrypt the data bit in the CAN bus message with AES encryption method.

The present embodiment may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided. Furthermore, only the CAN bus message of ECU related to the safety in driving in the CAN bus network may be encrypted, and thus the transmission efficiency of CAN bus messages may be improved while ensuring safety, and the cost for CAN bus may be reduced.

### Fifth Embodiment

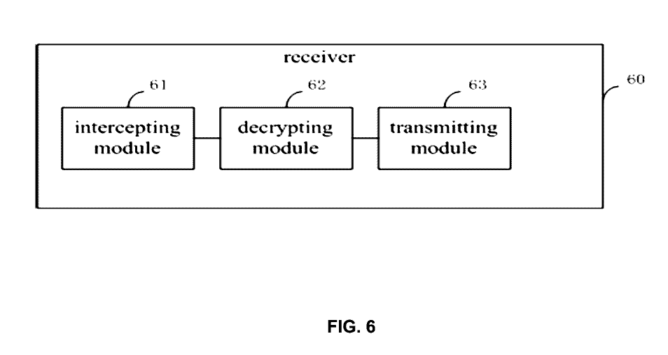

FIG. 6 is a structural diagram of a receiver 60 provided by the fifth embodiment of the present disclosure. As shown in FIG. 6, the receiver 60 may include: an intercepting module 61, a decrypting module 62, and a transmitting module 63.

The intercepting module 61 may be configured to perform interception on the CAN bus to acquire an encrypted CAN bus message of an ECU.

More particularly, the intercepting module 61 may perform interception on the CAN bus and acquire an encrypted CAN bus message whose value of Arbitration Field is same as the identification code of the ECU. The reason is that when data is transmitted at one node of the CAN bus, the data may be broadcast to all nodes in the network in a form of message. Each node may intercept the data no matter whether or not this message is intended to be transmitted to itself and compare the identification of itself and the value of the Arbitration Field of the message with respect to the message obtained by interception. If they are same, it means that the message obtained by interception is intended to be transmitted to itself. If they are different, it means that the message obtained by interception is not intended to be transmitted to itself.

The decrypting module 62 may be configured to decrypt the data field in the encrypted CAN bus message to obtain a message to be transmitted.

More particularly, the data field in the CAN bus message may be decrypted with a symmetry encryption algorithm same as the algorithm provided in the encrypting step, for example, Advanced Encryption Standard (AES).

The transmitting module 63 may be configured to transmit the message to be transmitted acquired by decryption by the decrypting module 62 to the ECU.

More particularly, ECU may receive the message to be transmitted and then perform corresponding operations according to the data field in the message to be transmitted.

The present embodiment may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided.

### Sixth Embodiment

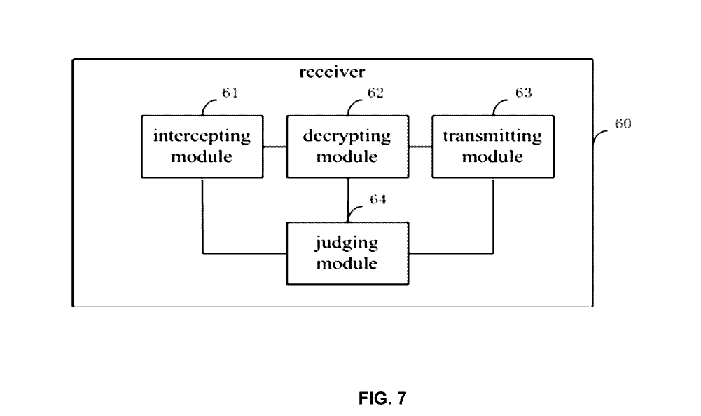

FIG. 7 is a structural diagram of another receiver 60 provided by the sixth embodiment of the present disclosure. As shown in FIG. 7, on the basis of foregoing embodiment, in the receiver 60, the data field in the CAN bus message may include an encryption indication bit and a data bit. The encryption indication bit may be configured to indicate whether or not the message is encrypted, wherein the data bit may be configured to carry data.

As a possible implementation, the encryption indication bit may be the first bit. For example, if the value of the encryption indication bit is 0, it means that the message is not encrypted, and it is unnecessary for the decrypting module 62 to perform decryption; and if the value of the encryption indication bit is 1, it means the message is encrypted and the decrypting module 62 may decrypt the message. In the decrypting module 62, the data bit in the data field in the message may be decrypted.

Accordingly, the receiver 60 may further include a judging module 64. The judging module 45 may be configured to confirm whether or not the CAN bus message is encrypted according to the indication of the encryption indication bit of the data field in the CAN bus message acquired by the intercepting module 61.

As a possible implementation, if the value of the encryption indication bit is 0, it means that the message is not encrypted, and the judging module 64 may transmit the encrypted CAN bus message to the transmitting module 63; and if the value of the encryption indication bit is 1, it means the message is encrypted and the judging module 45 may transmit the encrypted CAN bus message to the decrypting module 62 and in the decrypting module 62, the data bit in the data field in the message may be decrypted.

Accordingly, the decrypting module 62 may be further configured to decrypt the data bit in the CAN bus message with AES encryption method.

The present embodiment may enhance the security of CAN bus messages and solve the technical problem of leakage of information due to that the CAN bus may be vulnerable to attacks by encrypting the data field in the CAN bus message and thereby the data field may be transmitted in cipher-text during transmission. The reason is that in the related art, the CAN bus messages are always transmitted in plain-text and thus the CAN bus messages may be intercepted, hacked or counterfeited. More particularly, when the counterfeited messages appear on the CAN bus, vehicle braking may be caused, the gear box and engine may be out of control, which may threaten the safe in driving. With the technical solution of the present embodiment, such accidents may be avoided. Furthermore, only the CAN bus message of ECU related to the safety in driving in the CAN bus network may be encrypted, and thus the transmission efficiency of CAN bus messages may be improved while ensuring safety, and the cost for CAN bus may be reduced.

### Seventh Embodiment

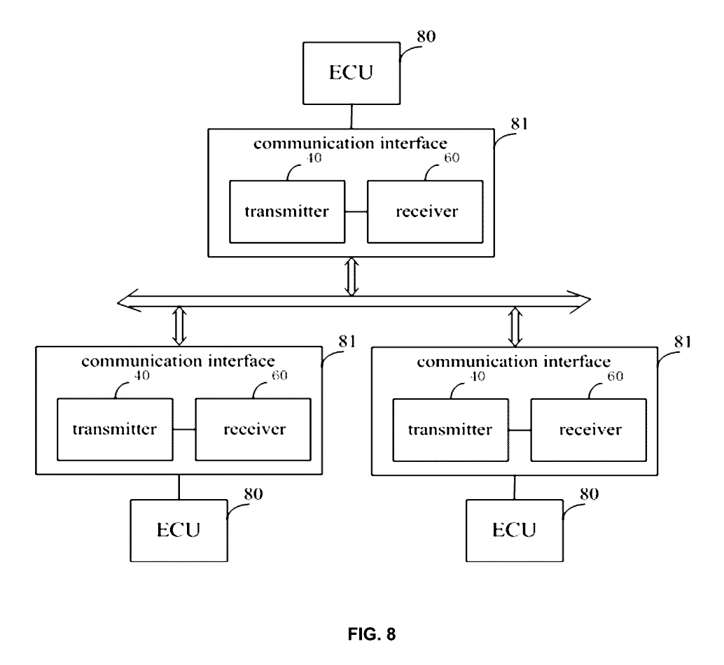

FIG. 8 is a structural diagram of a CAN bus network provided by the seventh embodiment of the present disclosure. As shown in FIG. 8, the CAN bus network may include the transmitter 40 and receiver 60 described in the foregoing embodiments, and an ECU 80 and a CAN bus. More particularly, the transmitter 40 and receiver 60 may be integrated into the communication interface 81. For the sake of description, in FIG. 8, the CAN bus may be represented only by a thick line.

The transmitter 40 may be connected with the ECU 80 and the CAN bus respectively. The receiver 60 may be connected with the ECU 80 and the CAN bus respectively.

It should be noted that, FIG. 8 only shows a possible CAN bus network, and the ECU 80 in the CAN bus network may be connected with the CAN bus via the transmitter 40 and receiver 60, and also may be connected with the CAN bus directly. That is to say, not all messages to be transmitted by the ECU 80 need to be transmitted in encryption. As a possible case, only the messages transmitted by the ECU 80 related to the safety in driving may be transmitted in encryption, and thus these ECUs 80 may be connected with the CAN bus via the transmitter 40 and receiver 60.

Only the CAN bus message of ECU related to the safety in driving in the CAN bus network may be encrypted, and thus the transmission efficiency of CAN bus messages may be improved while ensuring safety, and the cost for CAN bus may be reduced.

Furthermore, the transmitter 40 and receiver 60 may be integrated into the communication interface 81, and may be in a separate way. The above integrated units may be implemented in hardware or in a form of unit of hardware with software functions.

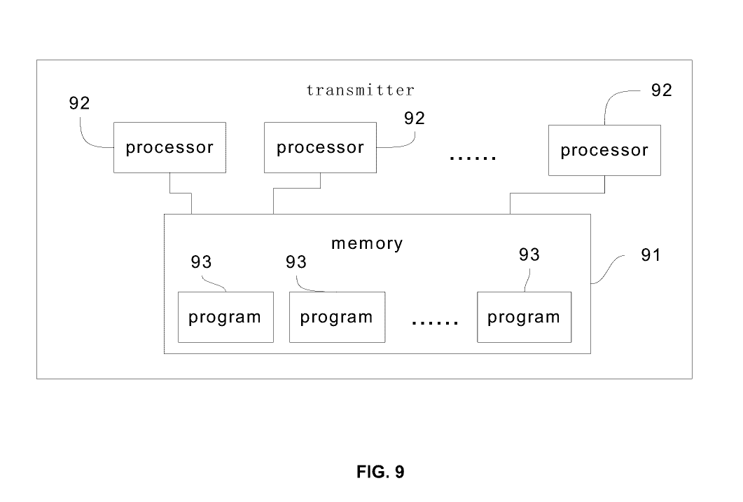

FIG. 9 is a structural block diagram for a transmitter according to another embodiment of the present disclosure, the present disclosure provides a transmitter, including: one or more processors; a memory; and one or more programs stored in the memory and configured to perform operations when executed by the one or more processors, wherein the operations include: acquiring a CAN bus message generated by an ECU; encrypting a data field in the CAN bus message to obtain a message to be transmitted; and transmitting the message to be transmitted on a CAN bus via broadcasting.

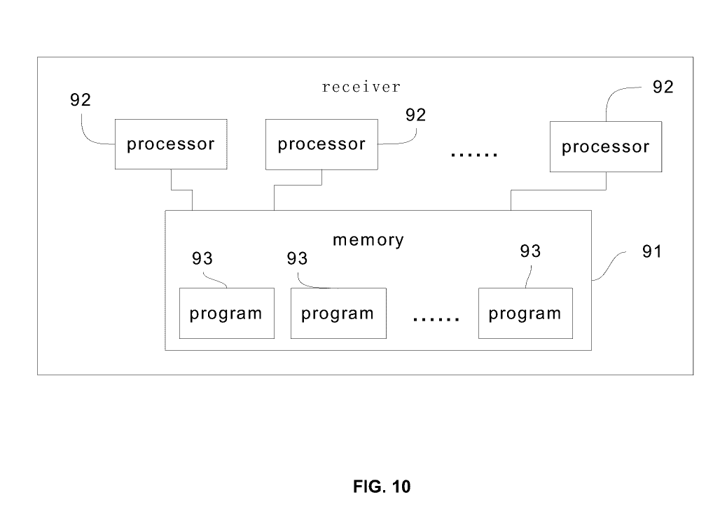

FIG. 10 is a structural block diagram for a receiver according to another embodiment of the present disclosure, the present disclosure provides a receiver, including: one or more processors; a memory; and one or more programs stored in the memory and configured to perform operations when executed by the one or more processors, wherein the operations include: performing interception on a CAN bus to acquire an encrypted CAN bus message of an ECU; decrypting a data field in the encrypted CAN bus message to obtain a message to be transmitted; and transmitting the message to be transmitted to the ECU.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. A data transmitting method, comprising:
acquiring a CAN bus message generated by an ECU;
encrypting a data field in the CAN bus message to obtain a message to be transmitted; and
transmitting the message to be transmitted on a CAN bus via broadcasting.

2. The data transmitting method according to claim 1, wherein the data field in the CAN bus message comprises an encryption indication bit and a data bit, and the encryption indication bit is configured to indicate whether or not the message is encrypted, and the data bit is configured to carry data,
wherein before the encrypting a data field in the CAN bus message to obtain a message to be transmitted, the data transmitting method further comprises:
confirming that the CAN bus message is encrypted according to the indication of the encryption indication bit of the data field in the CAN bus message.

3. The data transmitting method according to claim 2, wherein the encryption indication bit is a first bit in the data field.

4. The data transmitting method according to claim 2, wherein the encrypting a data field in the CAN bus message further comprises:
encrypting the data bit in the CAN bus message with an encryption method of Advanced Encryption Standard (AES).

5. The data transmitting method according to one of claims 1, wherein after the encrypting a data field in the CAN bus message to obtain a message to be transmitted, the data transmitting method further comprises:
performing validation check on the message to be transmitted according to an Arbitration Field and a CRC Field in the message to be transmitted.

6. A data receiving method, comprising:
performing interception on a CAN bus to acquire an encrypted CAN bus message of an ECU;
decrypting a data field in the encrypted CAN bus message to obtain a message to be transmitted; and
transmitting the message to be transmitted to the ECU.

7. The data receiving method according to claim 6, wherein the data field in the encrypted CAN bus message comprises an encryption indication bit and a data bit, and the encryption indication bit is configured to indicate whether or not the message is encrypted, and the data bit is configured to carry data;
wherein before the decrypting a data field in the encrypted CAN bus message to obtain a message to be transmitted, the data receiving method further comprises:
confirming that the encrypted CAN bus message is encrypted according to the indication of the encryption indication bit of the data field in the encrypted CAN bus message.

8. The data receiving method according to claim 7, wherein the encryption indication bit is a first bit in the data field.

9. The data receiving method according to claim 7, wherein the decrypting a data field in the encrypted CAN bus message further comprises: decrypting the data bit in the encrypted CAN bus message with an encryption method of Advanced Encryption Standard (AES).

10. The data receiving method according to one of claims 6, wherein the performing interception on the CAN bus to acquire an encrypted CAN bus message of an ECU further comprises:
performing interception on the CAN bus to acquire an encrypted CAN bus message whose value of Arbitration Field is same as an identification code of the ECU.

11. A transmitter, comprising:
one or more processors;
a memory; and
one or more programs stored in the memory and configured to perform operations when executed by the one or more processors, wherein the operations comprise:
acquiring a CAN bus message generated by an ECU;
encrypting a data field in the CAN bus message to obtain a message to be transmitted; and
transmitting the message to be transmitted on a CAN bus via broadcasting.

12. The transmitter according to claim 11, wherein the data field in the CAN bus message comprises an encryption indication bit and a data bit, and the encryption indication bit is configured to indicate whether or not the message is encrypted, and the data bit is configured to carry data,
wherein before encrypting a data field in the CAN bus message to obtain a message to be transmitted, the operation further comprises:
confirming that the CAN bus message is encrypted according to the indication of the encryption indication bit of the data field in the CAN bus message.

13. The transmitter according to claim 12, wherein the operation further comprises:
encrypting the data bit in the CAN bus message with an encryption method of Advanced Encryption Standard (AES).

14. The transmitter according to one of claims 11, wherein the operation further comprises:
performing validation check on the message to be transmitted according to an Arbitration Field and a CRC Field in the message to be transmitted.

15. A receiver, comprising:
one or more processors;
a memory; and
one or more programs stored in the memory and configured to perform operations when executed by the one or more processors, wherein the operations comprise:
performing interception on a CAN bus to acquire an encrypted CAN bus message of an ECU;
decrypting a data field in the encrypted CAN bus message to obtain a message to be transmitted; and
transmitting the message to be transmitted to the ECU.

16. The receiver according to claim 15, wherein the data field in the CAN bus message comprises an encryption indication bit and a data bit, and the encryption indication bit is configured to indicate whether or not the message is encrypted, and the data bit is configured to carry data; and
wherein before the decrypting a data field in the encrypted CAN bus message to obtain a message to be transmitted, the operation further comprises:
confirming that the encrypted CAN bus message is encrypted according to the indication of the encryption indication bit of the data field in the encrypted CAN bus message.

17. The receiver according to claim 16, the operation further comprises: decrypting the data bit in the encrypted CAN bus message with an encryption method of Advanced Encryption Standard (AES).

18. The receiver according to one of claims 15, wherein the operation further comprises:
performing interception on the CAN bus to acquire an encrypted CAN bus message whose value of Arbitration Field is same as an identification code of the ECU.

19. A CAN bus network, comprising:
a transmitter, comprising:
one or more processors;
a memory;
and
one or more programs stored in the memory and configured to perform operations when executed by the one or more processors, wherein the operations comprise:
acquiring a CAN bus message generated by an ECU;
encrypting a data field in the CAN bus message to obtain a message to be transmitted; and
transmitting the message to be transmitted on a CAN bus via broadcasting, the receiver according to one of claims 15, and a CAN bus,
wherein the transmitter is connected with the ECU and the CAN bus respectively, and the receiver is connected with the ECU and the CAN bus respectively.
